(19) United States
(12) Patent Application Publication
(10) Pub. No.: US 2005/0066766 A1
(43) Pub. Date: Mar. 31, 2005

(54) Handlebar mount shock absorber structure

(76) Inventor: Rich Orin Truchinski, Corona, CA (US)

Correspondence Address: Rich Truchinski, 2180 San Antonio Place, Corona, CA, 92882, US

(21) Appl. No.: 10/954,694

(22) Filed: Sep. 30, 2004

Related U.S. Application Data
(60) Provisional application No. 60/507,757, filed on Sep. 30, 2003.

(51) Int. Cl. B62K 21/12

(52) U.S. Cl. 74/551.1

(57) ABSTRACT

A handle bar mount for small vehicles and of the type having a pivoting handlebar cradle (24) attached to a top member (50) that is attached to a vehicle (20). A series of absorbers (38) is retained by an absorber posts (42). The location of the pivot is ideally suited rearward and lower than the handlebar clamp. This provides a simple and cost effective dampening of vibration from the ground, acceleration, and breaking to the handlebars and the rider.

### CROSS REFERENCE TO RELATED APPLICATION

This application claims priority to provisional application Ser. No. 60/507,757 filed Sep. 30, 2003.

### FIELD OF THE INVENTION

This invention relates to handlebar mounts, specifically to such mounts that are used for steering small vehicles such as a motorcycle. More specifically providing a shock absorbing mounting to handlebars that reduces some of the vibration from the ground to the rider.

### BACKGROUND OF THE INVENTION

Traditional ATV, bicycle and motorcycle handlebar mounting structures have for the most part utilized a solid mount handlebar cradle molded into the top steering member. Other designs include a solid bolted mounting interface between the upper steering member and handlebar cradles providing in some cases adjustment of handle bar position but no vibration or impact damping.

A significant improvement came when rubber bushings were included in a motorcycle handle bar cradle mount that was bolted to the top member using rubber bushings to insulate the vibration. Although the design is helpful during long periods of usage in reducing vibration transmitted to the handlebars, it has minimal effect on large impacts due to the minimal capacity for deformation of the bushings.

Other prior inventions have used mechanical hydraulic shock absorbing system that requires the use of highly precision machined telescoping tubes, seals, and fluid that must be contained in a sealed unit and requires maintenance to minimize fluid leaks.

U.S. Pat. No. 6,712,541 Henricksen (2004) discloses a triple clamp plus a handlebar clamp. This invention uses multiple dampers, but the dampers do not pivot on the clamp mechanism, the dampers provide rocking and normal damping of the handlebar. This invention also requires at least three clamps plus a handlebar clamp to operate.

U.S. Pat. No. 6,371,263 Hoose (2002) discloses a dampening system with springs and hydraulic fluid that provides the dampening. This invention uses multiple dampers, but the dampers do not pivot on the clamp mechanism, the dampers provide only normal forces to be applied to the dampers. This provides dampening when the handlebars are being pushed down, but provides minimal damping when the rider is accelerating. The assembly is also expensive and prone to leaking hydraulic fluid.

U.S. Pat. No. 5,511,444 Clausen and Allsop (1996) disclosed a system, which utilized parallel mounted arms and a damper unit. This patent describes using a shock absorbing bicycle handlebar assembly. This design requires the use of four pivots, which increased the complexity, and cost of the unit.

U.S. Pat. No. 6,325,402 B1 Gogo and Wakamatsu (2001) disclose a system, which utilizes a spring and shock to dampen vibrations and impacts. This patent describes using a spring and shock damping design. This design makes it possible to absorb down ward impacts and general vibrations. However it is less effective in absorbing forward impacts that are transmitted to the operator as a result of hard braking. Another disadvantage is the use of guide slots to limit travel of the handlebar holder that can reduce the damping of impacts and vibration to the handlebars at full travel and in an acceleration direction it does not provide any additional damping. In addition, the use of a cylindrical member for means of preload adjustment to the coil spring extends above the handlebar mount, which could result in a safety problem for the rider in the event of an accident.

Still other prior inventions have used a hard stop to limit movement of the handlebar cradle the proposed structure minimizes the impact that is transmitted to the operator when the handlebar cradle reaches full travel. As the force is increased the absorber overcomes the force of the impact at a progressive rate rather that stopping on a positive hard stop.

### BRIEF SUMMARY OF THE INVENTION

The object of the present invention is to provide a handlebar mounting structure that incorporates a pivoting handlebar cradle and a series of absorbers to create damping of vibration and impacts to the handlebars of a popular ATV, motorcycle or bicycle during operation and more specifically jumps, bumps de-acceleration and acceleration.

One feature of the present invention is the provision of a top member adapted to fit and retain a pair of forks or steering housing as a foundation for means of handlebar support.

In accordance with this object of the present invention is a pair of pivotally attached handlebar cradles mounted to the top member creating a secondary suspension for the handlebar cradles.

In accordance with this object of the present invention the pivot exists rearward and lower than the handlebar clamp.

In accordance with this object of the present invention is the provision of a series of absorber units fitted between and around the handlebar cradles and top member providing damping of vibration and impacts transmitted from the suspension to the handlebars. The use of the rubber absorbers will permit the use of the original handlebar and handlebar padding due to the location and size of the absorbers.

In accordance with this object of the present invention is the provision of a structure to retain said series of absorbers in place and to provide additional strength of the cradles when normal directional forces are applied as well as when lateral forces are applied. The opposing absorbers can be made stiffer or softer in compound and density as well as different shapes to control the movement of the handlebar. Additional bushing can be used at the handlebar cradle pivot minimizes the vibrations transmitted to the operator during operation.

Another feature of the present invention is a pivot for each handlebar cradle and a series of opposing bumpers that allows movement in a forward downward and upward backward direction which can absorb impacts transmitted from off road terrain without sacrificing the steering accuracy of the vehicle and is more suitable to the natural direction of the rider operator movement with minimal components and cost to the manufacture. The presence of the opposing absorbers allows cushioning in both an acceleration direction when the vehicle is under full throttle for example and in a braking direction when entering corners. It allows movement of the handlebar when braking to absorb the bumps and potholes that usually occur when that section of the terrain has many vehicles traveling and braking at the same point.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a motorcycle incorporating the present invention.

FIG. 2 is a right side view of the present invention removed.

FIG. 3 is a top view of the present invention top member with handlebar cradles removed.

FIG. 4 is a lower perspective view of the present invention removed.

FIG. 5 is a top perspective view of the present invention removed.

FIG. 6 shows a similar structure with absorbers in front and behind the pivot area.

FIG. 7 shows similar structure with two optional absorber positions (on the same drawing) sandwiching the handlebar cradle.

FIG. 8a&b show similar structures with optional holes and slots that allow handlebar position adjustment.

FIG. 9a-c shows the operation of the present invention.

FIG. 10 shows a similar structure with one-piece handlebar cradle and handlebar cradle top.

FIG. 11 shows a similar structure with the absorbers positioned at an angle.

FIG. 12 shows a similar structure that uses a hydraulic damper in conjunction with the absorbers.

### Drawings—Reference Numerals

| | |
|---|---|
| 20 | motorcycle |
| 22 | handlebar |
| 24 | (a, b) handlebar cradle bottom |
| 26 | upper fork tube |
| 28 | front wheel |
| 30 | handlebar cradle top |
| 32 | (a, b) handlebar pinch bolt |
| 34 | lower fork tube |
| 36 | (a, b, c, d) washer |
| 38 | (a, b, c, d, e, f, g, h, i) absorber |
| 40 | (a, b) retaining nut |
| 42 | (a, b) absorber post |
| 44 | pocket area |
| 46 | (a, b, c, d) handlebar cradle pivot |
| 48 | handlebar clamping area |
| 50 | top member |
| 56 | absorber post bore |
| 58 | bottom member |
| 60 | fork tube clamping area |
| 62 | steering stem bore |
| 64 | pinch clamp slot |
| 66 | slot |
| 68 | pin |
| 70 | bolt |
| 72 | bushing |
| 74 | suspension assembly |
| 76 | hydraulic damper |
| 80 | (a, b, c) pivot locations |

### DETAILED DESCRIPTION OF THE INVENTION

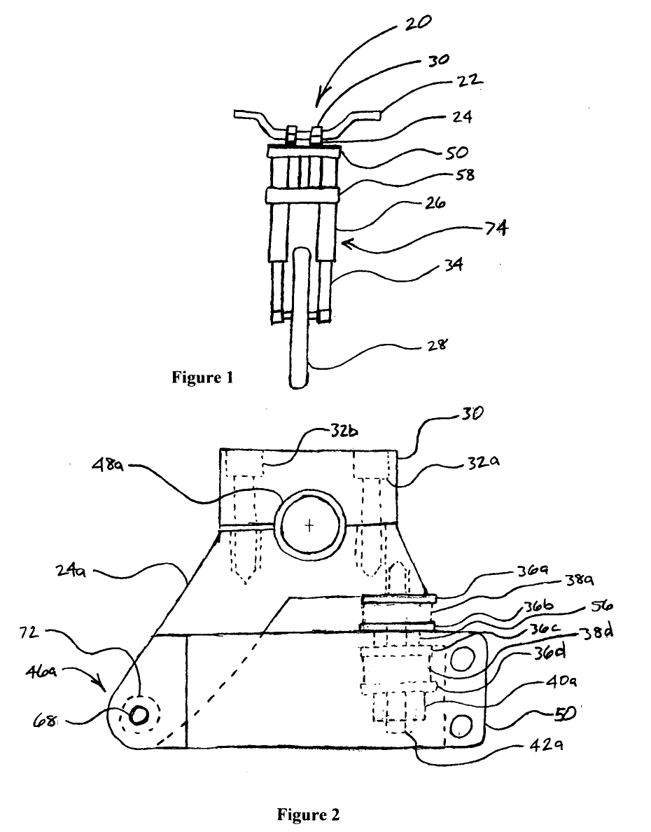

FIG. 1 shows a perspective view of a motorcycle incorporating a preferred embodiment of the invention. A front prior art suspension assembly 74 has a bottom member 58 and a top member 50 pivotally connectable to the motorcycle 20 and a pair of telescoping upper fork tube 26 and lower fork tube 34 sets. A front wheel 28 is connected to the pair of lower fork tubes 34. A pair of handlebar cradle bottoms 24 is pivotally attached to top member 50. The pair of handlebar cradle bottoms is symmetrical and is mounted in a direction of the width of the motorcycle. Each handlebar cradle bottom 24a is connected via a handlebar cradle pivot 46a as shown in FIG. 2, to the top member 50 which allows movement of a handlebar 22 retained by a pair of handlebar cradle tops 30 and a series of handlebar pinch bolts 32a, 32b shown in FIG. 2. An absorber post 42a extends through a corresponding absorber post bore 56 to the lower side of top member 50. A set of upper 38a and lower 38d absorbers is held in place by absorber post 42a and a retaining nut 40a to create damping of vibrations and impacts during acceleration, braking and maneuvering obstacles for example, on off road terrain. A series of washers 36a, b, c, d provide a maintainable surface for absorbers 38a, 38d to interface with.

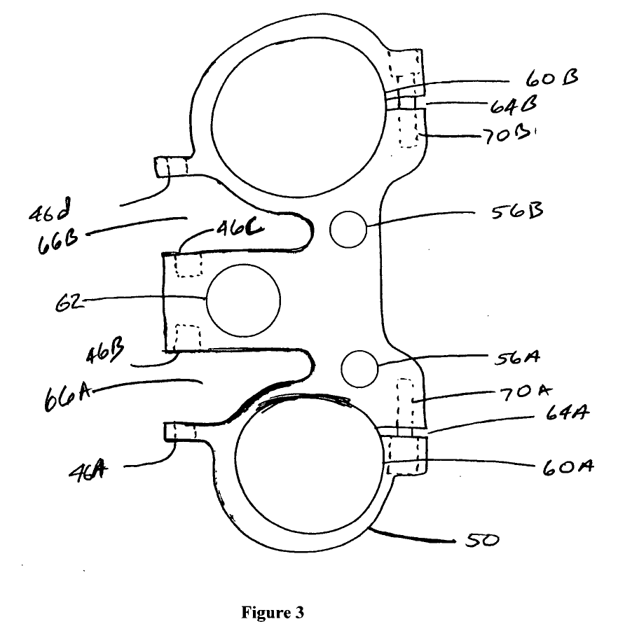

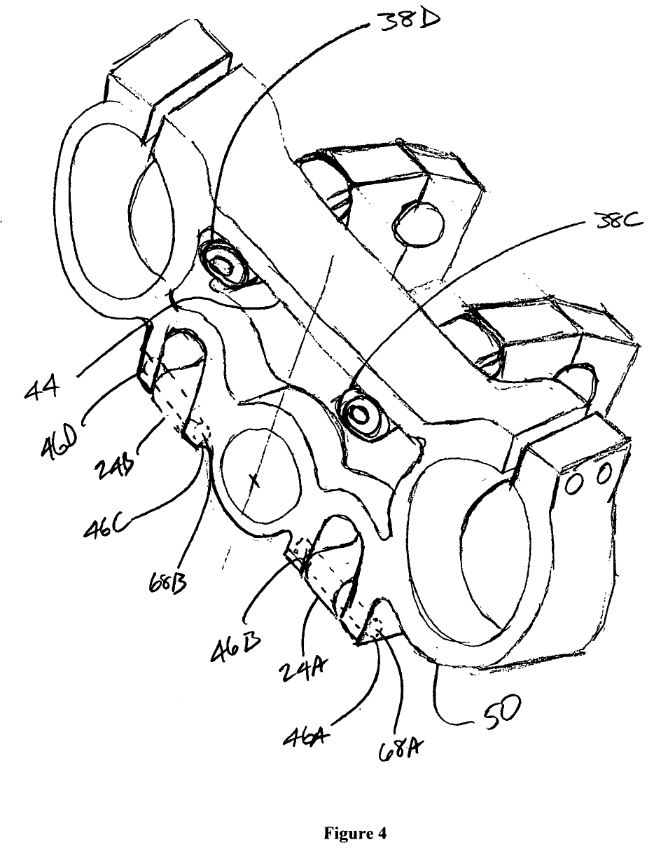

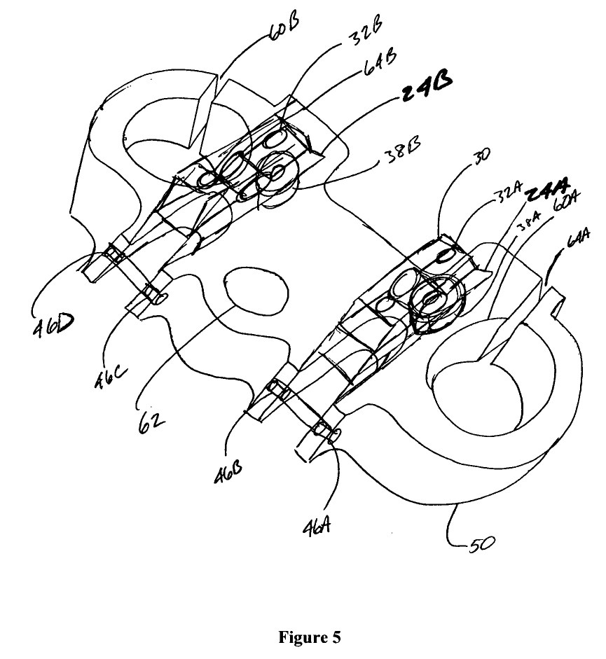

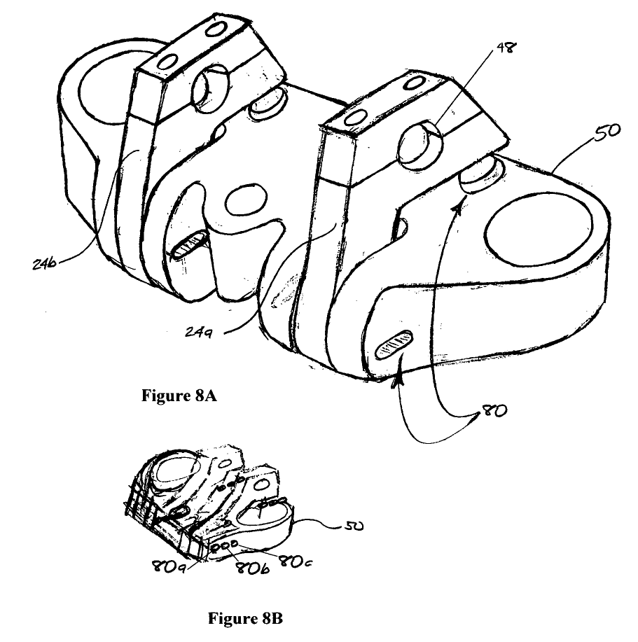

FIG. 3 shows top member 50 with handlebar cradle bottoms removed to show a pair of slots 66a, 66b where the handlebar cradle bottoms attach and their relationship to absorber post bore 56a, 56b and steering stem bore 62. Each slot 66a, 66b is an area for the handlebar cradle bottom to fit between, providing areas for handlebar cradle pivot 46a, 46b, 46c, and 46d to be machined where a pins 68a, 68b are located as shown in FIG. 4. Pins 68a, 68b could be a threaded bolt, solid pin or hollow pin, referring back to FIG. 3. Fork tube clamping area 60a, 60b retains upper fork tube when bolt 70a, 70b is tightened closing pinch clamp slot 64a, 64b until top member 50 is holding upper fork tubes 26 as shown in FIG. 1 secure. This is the most common method the motorcycle manufactures use to retain upper fork tubes shown in FIG. 4. The bottom of top member 50 (FIG. 4) has a pocket area 44 where each lower absorber 38c, 38d is located. This bushing can be made of plastic, rubber, brass, bronze, aluminum, or a combination of these materials or other materials that provide similar results. Pocket area 44 is an area that allows deformation of each absorber 38c, 38d. This also applies to the open area on the upper side of top member 50 shown in FIG. 5, where the upper absorbers 38 are located. This in turn allows each respective handlebar cradle bottom to move depending on the hardness and shape of absorber 38a, 38b, 38c, 38d shown in FIGS. 4 and 5. The material composition, hardness and shape of each absorber 38a, 38b, 38c, and 38d can be changed to control the movement of handlebar cradle bottom 24 shown in FIG. 1. For example they could be rubber, polyurethane or any combination of a rubberized plastic composition that would aid in the proper amount of absorption for the given environment. In addition to the shape of absorber 38a, 38b, 38c, 38d, the shape of washer 36a, 36b can be changed likewise to also aid in the control of the handlebar cradle bottom 24. In FIG. 2 the absorbers 38a, 38b, 38c, 38d are square shaped. In FIG. 7 the absorbers 38h, 38i are wedge as well as square shaped. Any combination of these shapes and other shapes may also aid in the control of the handlebar cradle bottom.

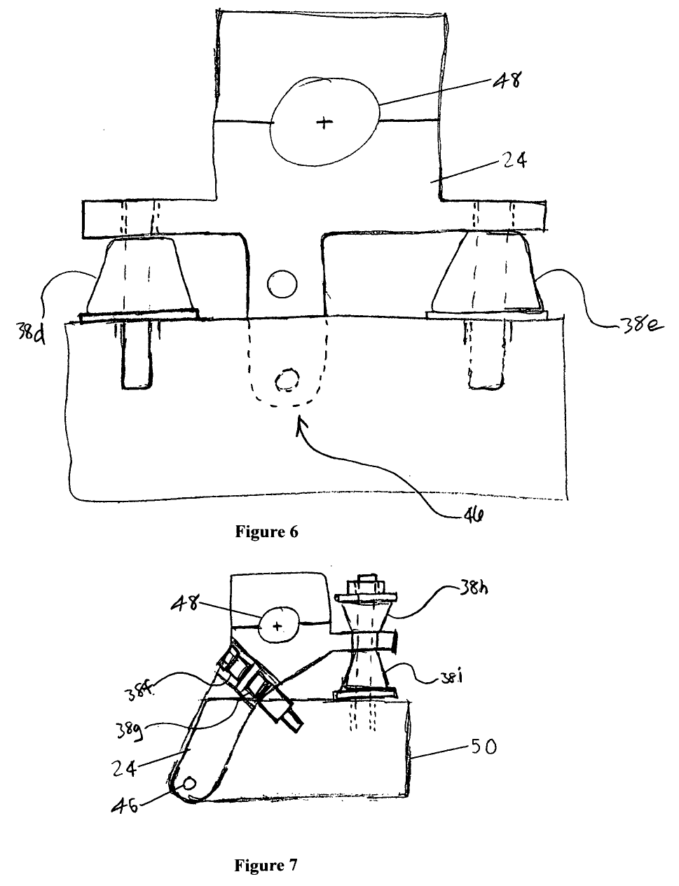

Additional embodiments are shown in FIGS. 6, 7a, and 8a&b; in each case the handlebar cradle pivots 24 and or 24a, 24b allow movement of the handlebar. There are various possibilities with regard to the position of the handle bar cradle pivot and absorbers. FIG. 6 shows the pivot 46 in a central location between the absorbers 38d, 38e FIG. 7a show structures with absorbers 38f, 38g, 38h, 38i sandwiching the handlebar cradle 24 instead of sandwiching the top member 50. The handlebar pivot 46 is located rearward and lower than the handlebar clamping area 48 is the preferred location. This allows the most natural motion in conjunction with the operator/rider during braking, acceleration and downward forces during landings from jumps and bumps.

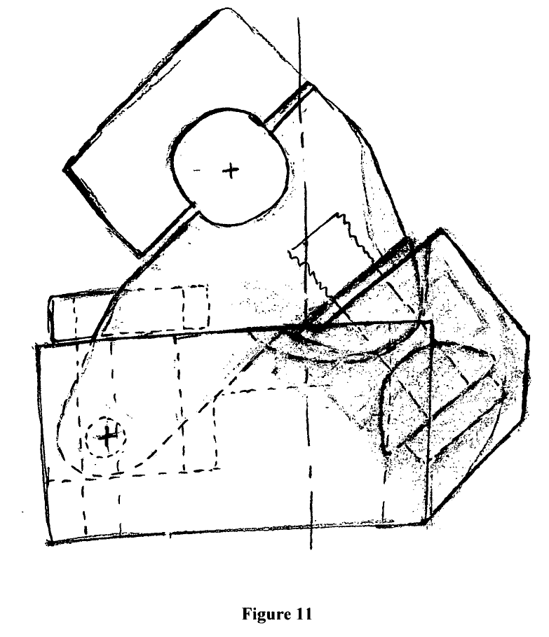

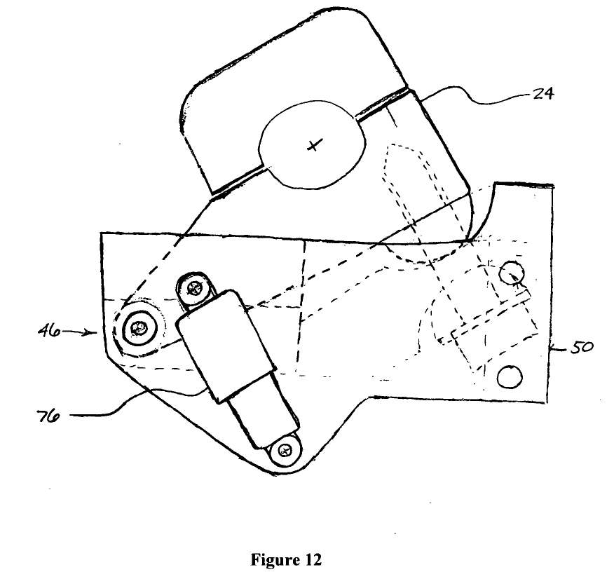

Various possibilities with regard to relative disposition of handle bar location are contemplated. In FIG. 8a the top member 50 has elongated pivot 80 and postholes that allow the user to adjust handle bar cradle 24a, 24b position forward or backward. In FIG. 8b top member 50 has three different locations for the handlebar cradle pivots and posts to be located 80, 80a, 80b, 80c. An additional adjustment can be made by supplying different size absorbers and absorber posts that would adjust the handlebar cradle higher or lower. FIG. 10 shows a one-piece handlebar cradle and handlebar cradle top. This can create additional lateral rigidity and possibly additional clamping strength for handlebars resisting slipping of the handlebars. In FIG. 11 the absorbers have been positioned at an angle that would possibly better absorb braking and acceleration bumps. FIG. 12 shows a structure utilizing a hydraulic damper 76 unit to control the motion of the handlebars in conjunction with the handlebars. This could possibly be a better combination of the non-mechanical rubber style absorbers and a hydraulic damper which could possibly better control the motion of the handlebar cradles during operation over all types of obstacles previously mentioned.

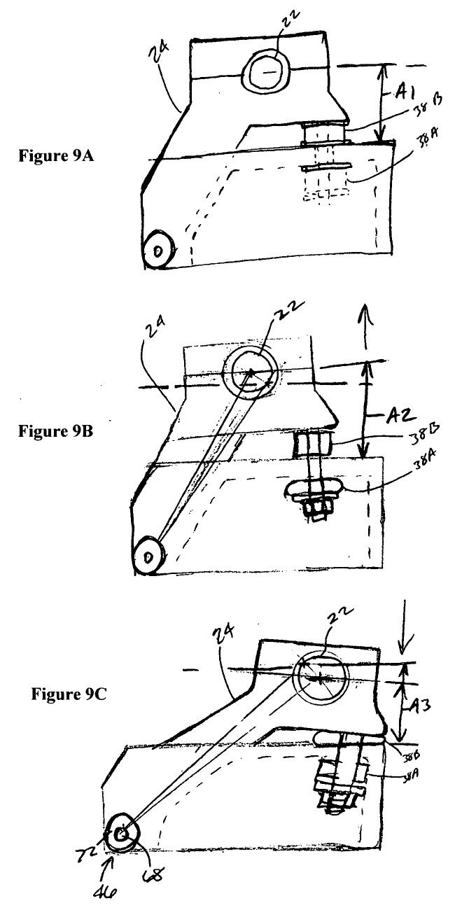

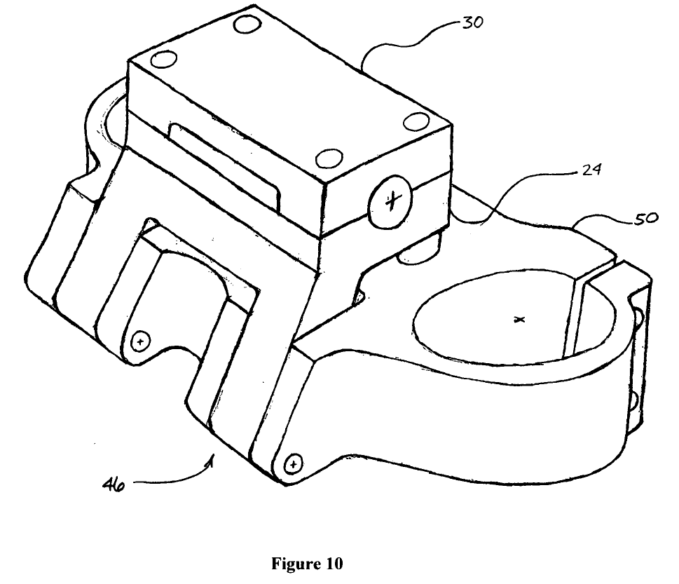

The operation of the handlebar mount shock absorber structure is shown in FIGS. 9a-c. FIG. 9a shows a state where external force is not applied to the handlebar and where distance “A1” is the neutral position. FIG. 9b shows the lower absorber 38a in compression for example when the bike is accelerating and the rider is pulling on the handlebar 22 in handlebar cradle 24. This action absorbs the impact felt by the rider and distance “A2” has increased in an upward and rearward direction. FIG. 9c shows the upper absorber 38a in compression when the rider and bike are decelerating or landing from a jump. Distance “A3” has decreased whereby absorbing the force in a downward and forward direction.

1. A handlebar mount shock absorber structure for a vehicle, said handlebar mount comprising:
a first member for attachment to a vehicle:
a second member for mounting to handlebars of said vehicle,
wherein the first member is pivotally attached to the second, and
the second member includes at least one absorber to limit and dampen rotation of first and second member.

2. The vehicle in claim 1 wherein the vehicle is an ATV, bicycle, motorcycle or something other than an ATV, bicycle and motorcycle.

3. The attachment of the first member to the vehicle wherein the attachment is at least one pinch clamp.

4. The mounting of the second member from claim 1 wherein the mounting is at least one pinch clamp.

5. The pivotal attachment from claim 1 wherein the pivotal attachment comprises at least one pin or bearing.

6. The absorber from claim 1 wherein the absorber is fluid filled.

7. The absorber from claim 1 wherein the absorber is gas filled.

8. The absorber from claim 1 wherein the absorber is a spring.

9. The absorbers from claim 1 wherein the absorbers are made from material consisting of plastic, rubber, brass, bronze, aluminum or something other than plastic, rubber, brass, bronze, aluminum

10. The absorbers from claim 1 wherein the absorbers are shaped round, cylindrical, pyramid, toroidal or something other than round, cylindrical, pyramid, toroidal

11. The attachment of the pivot from claim 1 wherein the pivot exists rearward of the handlebar mounting.

12. The attachment of the pivot from claim 1 wherein the pivot exists lower than the handlebar mount.

13. The absorbers in claim 1 wherein the dampers can be replaced or changed.

14. The attachment of the first member to the vehicle wherein the attachment is at least one mechanical interface.
